(19) United States
(12) Patent Application Publication
(10) Pub. No.: US 2012/0063378 A1
(43) Pub. Date: Mar. 15, 2012

(54) METHOD, APPARATUS AND SYSTEM FOR PROVIDING MULTICAST SERVICE IN A COMMUNICATION SYSTEM

(75) Inventors: Se-Ho KIM, Seoul (KR); Byung-Wook JUN, Seoul (KR); Hee-Won KANG, Seongnam-si (KR)

(73) Assignee: SAMSUNG ELECTRONICS CO. LTD., Suwon-si (KR)

(21) Appl. No.: 13/227,832

(22) Filed: Sep. 8, 2011

(30) Foreign Application Priority Data
Sep. 14, 2010 (KR) 10-2010-0089772
Nov. 9, 2010 (KR) 10-2010-0111108

(51) Int. Cl. H04W 4/06

(52) U.S. Cl. 370/312

(57) ABSTRACT

Methods for providing a multicast service by a Base Station (BS) and a Mobile Station (MS) in a communication system, and a BS and an MS for performing the methods, are provided. The method for providing a multicast service by a BS in a communication system includes providing a multicast service to an MS using a multicast group IDentifier (ID) used to uniquely identify a multicast service in a network, and a Flow ID (FID) used along with the multicast group ID to uniquely identify a multicast flow in the network.

### PRIORITY

This application claims the benefit under 35 U.S.C. §119(a) of a Korean patent application filed in the Korean Intellectual Property Office on Sep. 14, 2010 and assigned Serial No. 10-2010-0089772, and a Korean patent application filed in the Korean Intellectual Property Office on Nov. 9, 2010 and assigned Serial No. 10-2010-0111108, the entire disclosure of each of which is hereby incorporated by reference.

### BACKGROUND OF THE INVENTION

1. Field of the Invention

The present invention relates to a multicast service in a communication system. More specifically, the present invention relates to a method, apparatus and system for providing a multicast service in a communication system.

2. Description of the Related Art

Next-generation communication systems have evolved to provide a variety of high-speed, high-capacity services to Mobile Stations (MSs). Examples of the next-generation communication systems include an Institute of Electrical and Electronics Engineers (IEEE) 802.16 communication system and a Mobile Worldwide Interoperability for Microwave Access (WiMAX) communication system.

An example of the IEEE 802.16 communication system includes an IEEE 802.16m communication system, in which a Base Station (BS) allocates resources to MSs individually, and transmits resource allocation information (i.e., resource allocation Information Elements (IEs)) for the individual resources allocated to the MSs, to the MSs using a MAP message. The resource allocation IEs may include information about locations and sizes of the allocated resources, information about modulation schemes and coding rates to be used for the allocated resources, etc.

In the IEEE 802.16m communication system, a BS may transmit data using a multicast scheme. In this case, the BS may transmit multicast data using multicast resources included in an Enhanced Multicast Broadcast Service (E-MBS) zone.

Currently, however, only the principle of a multicast service provision scheme has been suggested, hinting at the possibility of transmitting multicast data using multicast resources included in an E-MBS zone in the IEEE 802.16m communication system, and its specific scheme for providing the multicast service has not yet been proposed.

Therefore, there is a need for a specific scheme for providing the multicast service in the IEEE 802.16m communication system.

### SUMMARY OF THE INVENTION

Aspects of the present invention are to address at least the above-mentioned problems and/or disadvantages and to provide at least the advantages described below. Accordingly, an aspect of the present invention is to provide a method, apparatus and system for providing a multicast service in a communication system.

In accordance with an aspect of the present invention, a method for providing a multicast service by a Base Station (BS) in a communication system is provided. The method includes providing a multicast service to a Mobile Station (MS) using a multicast group IDentifier (ID) used to uniquely identify a multicast service in a network, and a Flow ID (FID) used along with the multicast group ID to uniquely identify a multicast flow in the network.

In accordance with another aspect of the present invention, a method for receiving a multicast service by an MS in a communication system is provided. The method includes receiving a multicast service from a BS using a multicast group ID used to uniquely identify a multicast service in a network, and an FID used along with the multicast group ID to uniquely identify a multicast flow in the network.

In accordance with further another aspect of the present invention, a BS in a communication system is provided. The BS includes a control unit for controlling to provide a multicast service to an MS using a multicast group ID used to uniquely identify a multicast service in a network, and an FID used along with the multicast group ID to uniquely identify a multicast flow in the network.

In accordance with yet another aspect of the present invention, an MS in a communication system is provided. The MS includes a control unit for controlling to receive a multicast service from a BS using a multicast group ID used to uniquely identify a multicast service in a network, and an FID used along with the multicast group ID to uniquely identify a multicast flow in the network.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an internal configuration of an Institute of Electrical and Electronics Engineers (IEEE) 802.16m communication system according to an exemplary embodiment of the present invention;

FIG. 2 illustrates an operation of a Base Station (BS) in an IEEE 802.16m communication system according to an exemplary embodiment of the present invention;

FIG. 3 illustrates an operation of a Mobile Station (MS) in an IEEE 802.16m communication system according to an exemplary embodiment of the present invention;

FIG. 4 illustrates an internal structure of a BS in an IEEE 802.16m communication system according to an exemplary embodiment of the present invention; and

FIG. 5 illustrates an internal structure of an MS in an IEEE 802.16m communication system according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method, apparatus and system for providing a multicast service in a communication system. In addition, exemplary embodiments of the present invention provide a method, apparatus and system for providing a multicast service using a multicast group IDentifier (ID), a Flow ID (FID), and a Multicast FID (MFID).

While an Institute of Electrical and Electronics Engineers (IEEE) 802.16m communication system will be considered herein as an example of the communication system, it will be understood by those of ordinary skill in the art that the multicast service provision method, apparatus and system proposed by the exemplary embodiments of the present invention may be used not only in the IEEE 802.16m communication system, but also in other communication systems such as a Mobile Worldwide Interoperability for Microwave Access (WiMAX) system.

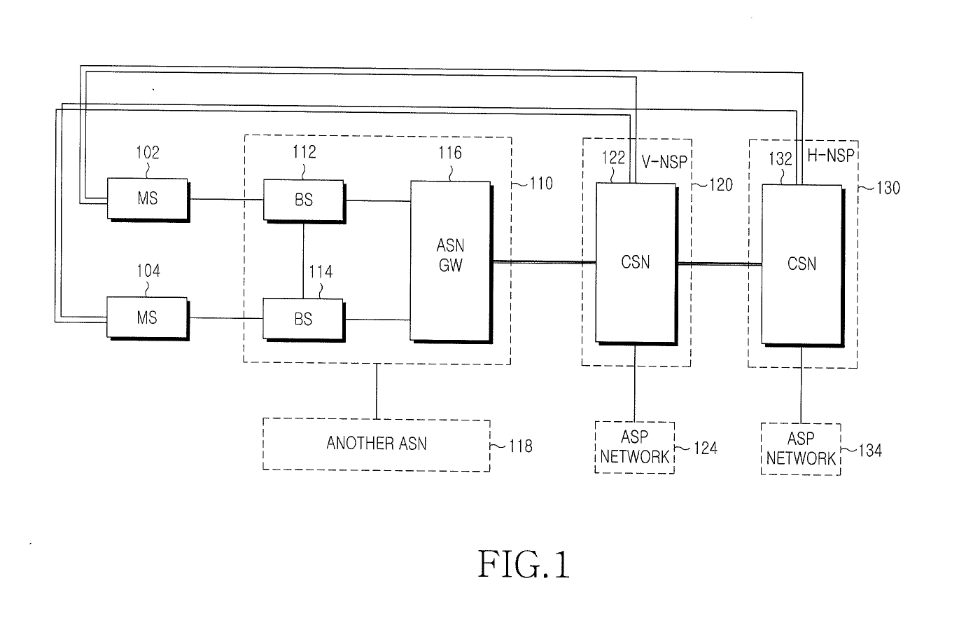

FIG. 1 illustrates an internal configuration of an IEEE 802.16m communication system according to an exemplary embodiment of the present invention.

Referring to FIG. 1, the IEEE 802.16m communication system includes one or more Mobile Stations (MSs) 102 and 104, one or more Access Service Networks (ASNs) 110 and 118, and one or more Connectivity Service Networks (CSNs) 122 and 132.

The CSNs 122 and 132 are included in a Visited Network Service Provider (V-NSP) 120 and a Home Network Service Provider (H-NSP) 130, respectively, in which their associated MSs 102 and 104 are registered, and may access Access Service Provider (ASP) networks 124 and 134 such as the Internet, respectively.

The ASN 110 includes functional blocks performing network functions for providing wireless access to users carrying the MSs 102 and 104. Specifically, the ASN 110 supports the MSs 102 and 104 to be able to access the network by setting up Layer-1 and Layer-2 accesses to the MSs 102 and 104 and setting up a Layer-3 access to the Network Service Providers (NSPs) 120 and 130, and manages wireless resources for efficient wireless communication of the MSs 102 and 104. For mobility management, the ASN 110 provides functions such as ASN-anchored mobility, CSN anchored mobility, paging, and ASN-CSN tunneling. To this end, the ASN 110 includes one or more Base Stations (BSs) 112 and 114 connected to the MSs 102 and 104, and at least one ASN gateway 116 connected to the NSPs 120 and 130.

The CSNs 122 and 132 include functional blocks performing network functions for providing Internet Protocol (IP) connectivity services to the users carrying the MSs 102 and 104. Specifically, the CSNs 122 and 132 allocate IP addresses and endpoint parameters for user sessions to the MSs 102 and 104, support ASN-CSN tunneling and inter-CSN tunneling, and manage inter-ASN mobility.

In the IEEE 802.16m communication system, MSs are identified by STation IDs (STIDs), each of which has a 4-bit FID. The FID is an ID for identifying a service flow, and its service-related parameters are allocated through a Dynamic Service Allocation (DSA) process. The service-related parameters include a service type, Quality of Service (QoS), supportable services, etc.

If a service that a BS or an MS wants to provide occurs, the BS and MS share information about the service through the DSA process. The BS transmits resource allocation information using an STID in order to allow the MS to provide the service so that the MS may receive the resource allocation information for resources allocated to the MS itself. The resource allocation information is included in a MAP message.

A burst that the MS receives includes an Advanced Generic Medium Access Control (MAC) Header (AGMH), and the AGMH includes an FID and burst length information of the burst. The MS may detect the FID included in the AGMH, and identify a flow of the received burst based on the detected FID. The MS performs an operation related to the flow information corresponding to the FID detected in the DSA process. In the IEEE 802.16m communication system, service identification and resource allocation are performed using STIDs and FIDs.

In the IEEE 802.16m communication system, a BS may transmit data using a multicast scheme. In this case, the BS may transmit multicast data using multicast resources included in an Enhanced Multicast Broadcast Service (E-MBS) zone.

Currently, however, only the principle of a multicast service provision scheme has been suggested, hinting at the possibility of transmitting multicast data using multicast resources included in an E-MBS zone in the IEEE 802.16m communication system.

Therefore, exemplary embodiments of the present invention provide a specific scheme for providing the multicast service in the IEEE 802.16m communication system.

A group in which MSs receiving the same multicast service are included, i.e., a multicast group includes at least one MS, and for convenience of description, it will be assumed herein that one multicast group includes a plurality of MSs. Multicast groups are identified by their unique multicast group IDs, and MSs included in a multicast group may receive the multicast service using a group ID for the multicast group. A BS may notify a multicast group ID to MSs included in the related multicast group through, for example, a DSA process. It will be understood by those of ordinary skill in the art that the BS may notify the multicast group ID to the MSs included in the related group through a process other than the DSA process.

It will be assumed that in the IEEE 802.16m communication system, an FID has, for example, 4 bits, and the IEEE 802.16m communication system uses, for example, 16 FIDs. A multicast service refers to a service that multiple MSs are receiving, and the MSs receiving the multicast service should have the same multicast group ID and FID. However, in the situation where each MS already uses an FID for its STID, it is difficult to generate a multicast group ID and match FIDs of all MSs that receive the multicast service.

Therefore, exemplary embodiments of the present invention provide a scheme of mapping multicast group IDs, MFIDs, and FIDs to provide multicast services. The multicast group IDs may be independently recognized in a network, and the mapping between the multicast group IDs, MFIDs, and FIDs is performed through a DSA process.

A multicast service refers to a service that is provided to multiple MSs in the same way. If MSs receiving the same multicast service are distributed over multiple BSs, the multiple BSs provide the same multicast service using the same multicast group ID. Therefore, a separate update process is not required even when an MS(s) performs a handover operation or a network reentry operation. A multicast group ID proposed by exemplary embodiments of the present invention may be defined as shown in Table 1 below.

TABLE 1

| | |
|---|---|
| Multicast Group | A 16-bit value that is used to uniquely identify a multicast |
| Identifier | service in a network. |

In Table 1, ‘Multicast Group Identifier’ having, for example, 16 bits, is used to uniquely identify a multicast service in the network.

In addition, exemplary embodiments of the present invention provide a scheme of providing a multicast service using an MFID, an FID and a multicast group ID. The MFID is an FID that is mapped in common to all multicast group IDs. In other words, the MFID is an FID given to provide a multicast service, and a multicast service flow may be identified by an MFID. An MFID proposed by exemplary embodiments of the present invention may be defined as shown in Table 2 below.

TABLE 2

| | |
|---|---|
| MFID | FID for Multicast connection, called MFID, is used along with |
| | a 16-bit Multicast Group ID to uniquely identify a specific |
| | Multicast flow in a network. |

In Table 2, ‘MFID’ is used along with a multicast group ID having, for example, 16 bits, to uniquely identify a specific multicast flow in the network.

A multicast service is provided on a multicast group basis, and allocation of the multicast group and the multicast service is achieved through a DSA process. In the case of a group call such as the multicast service, because the group call may be serviced based on multiple groups, multiple multicast group IDs should be mapped to one MFID in the DSA process.

In the IEEE 802.16m communication system, multicast group IDs should be mapped to an MFID in a DSA process. In order to make it possible to map multiple multicast group IDs to one MFID, exemplary embodiments of the present invention may define an Advanced Air Interface DSA Request (AAI_DSA-REQ) message in Table 3 below, an AAI_DSA Response (AAI_DSA-RSP) message in Table 4 below, and an AAI Dynamic Service Change Request (AAI_DSC-REQ) message in Table 5 below.

TABLE 3

| | Attributes/Array | Size | | |
|---|---|---|---|---|
| M/O | of attributes | (bits) | Value/Note | Condition |
| | . . . | | | |
| O | Num of Multicast | 4 | Number of | Present when |
| | Group ID | | Multicast group | Num of Multicast |
| | | | to add | Group ID > 0 |
| M | Multicast Group | 16 | ID of a group to | Present when |
| | ID | | which the flow is | Num of Multicast |
| | | | added | Group ID > 0 |
| O | MFID | 4 | Flow of Multicast | Present when |
| | | | Groups | Num of Multicast |
| | | | The MFID is | Group ID > 0 |
| | | | mapped to FID. | |

In Table 3, ‘Num of Multicast Group ID’ represents the number of multicast group IDs, ‘Multicast Group ID’ represents a multicast group ID of a multicast group to which a flow is added, and ‘MFID’ represents a flow of multicast groups.

TABLE 4

| | Attributes/Array | Size | | |
|---|---|---|---|---|
| M/O | of attributes | (bits) | Value/Note | Condition |
| | . . . | | | |
| O | Num of Multicast | 4 | Number of | Present when |
| | Group ID | | Multicast group | Num of Multicast |
| | | | to add | Group ID > 0 |
| M | Multicast Group | 16 | ID of a group to | Present when |
| | ID | | which the flow | Num of Multicast |
| | | | is added | Group ID > 0 |
| O | MFID | 4 | Flow of | Present when |
| | | | Multicast | Num of Multicast |
| | | | Groups | Group ID > 0 |
| | | | The MFID is | |
| | | | mapped to FID. | |

TABLE 5

| | Attributes/Array | Size | | |
|---|---|---|---|---|
| M/O | of attributes | (bits) | Value/Note | Condition |
| | . . . | | | |
| O | Num of Multicast | 4 | Number of | Present when ABS |
| | Group ID to add | | Multicast Group | initiates AAI_DSC- |
| | | | IDs to add | REQ |
| | | | | Present only if Num |
| | | | | of Multicast Group |
| | | | | ID to add > 0 |
| M | Multicast Group | 16 | Multicast Group | Present only if Num |
| | ID to be added | | ID to be added | of Multicast Group |
| | | | | ID to add > 0 |
| O | MFID | 4 | Flow of newly | Present when Num |
| | | | added Multicast | of Multicast Group |
| | | | Groups | ID to add > 0 |
| | | | The MFID is | |
| | | | mapped to FID. | |
| O | Num of Multicast | 4 | Number of | Present when ABS |
| | Group ID to delete | | Multicast Group | initiates AAI_DSC- |
| | | | IDs to delete | REQ |
| | | | | Present only if Num |
| | | | | of Multicast Group |
| | | | | ID to delete > 0 |
| M | Multicast Group | 16 | Multicast Group | Present only if Num |
| | ID to be deleted | | ID to be deleted | of Multicast Group |
| | | | | ID to delete > 0 |

In Table 5, ‘Num of Multicast Group ID to add’ represents the number of added multicast group IDs, ‘Multicast Group ID to be added’ represents a multicast group ID to be added, ‘MFID’ represents a flow of multicast group IDs to be newly added, ‘Num of Multicast Group ID to delete’ represents the number of deleted multicast group IDs, and ‘Multicast Group ID to be deleted’ represents a multicast group ID to be deleted.

For unicast services based on STIDs, a BS may transmit an FID in an AGMH. On the other hand, for multicast services based on multicast group IDs, the BS may transmit an MFID in an AGMH. A format of the AGMH including an MFID is as shown in Table 6 to Table 8 below.

TABLE 6

The AGMH format is defined in Table 653. For E-MBS
services, the FID shall be ignored by the receiver.
For Multicast service, the FID shall be replaced by MFID.

‘Table 653’, a table defined in the IEEE 802.16m D8 standard, the entire disclosure of which is hereby incorporated by reference, which is used in the IEEE 802.16m communication system, defines a format of an AGMH.

For E-MBS services, the FID shall be ignored by the receiver, and for Multicast service, the FID shall be replaced by MFID in the format of the AGMH in Table 6.

TABLE 7

The AGMH format is defined in Table 653. For E-MBS services, the
FID shall be ignored by the receiver. For Multicast service, the FID
shall be replaced by MFID of corresponding Multicast Group ID.

For E-MBS services, the FID shall be ignored by the receiver, and for Multicast service, the FID shall be replaced by MFID of corresponding Multicast Group ID in the format of the AGMH in Table 7.

TABLE 8

The AGMH format is defined in Table 653. For E-MBS services,
the FID shall be ignored by the receiver. For Multicast
service, the MFID associated with Multicast Group ID shall be
used in FID field of AGMH.

For E-MBS services, the FID shall be ignored by the receiver, and for Multicast service, the MFID associated with Multicast Group ID shall be used in FID field of AGMH in Table 8.

Otherwise, in order to enable to map one MFID to one Multicast Group ID, each of an AAI_DSA-REQ message, an AAI_DSA-RSP message, and an AAI_DSC-REQ message proposed by exemplary embodiments of the present invention may be newly defined as shown in Table 9 to Table 11 below.

Firstly, a format of the newly defined AAI_DSA-REQ message is as shown in Table 9 below.

TABLE 9

| Field | Size(bit) | Value/Description | Condition |
|---|---|---|---|
| . . . | | | |
| For (i=0; i<Num | | Num of Multicast Group ID | Present when |
| of Multicast | | is the number of Multicast | ABS initiates |
| Group ID; i++) { | | Group IDs to add | AAI-DSA- |
| | | [1 . . . 16] | REQ |
| | | | Present only if |
| | | | Num of |
| | | | Multicast |
| | | | Group ID > 0 |
| Multicast Group | 12 | ID of a group to which the | |
| ID | | flow is added | |
| MFID | 4 | FID which is associated | Present when |
| | | with Multicast Group IDs | Num of |
| | | | Multicast |
| | | | Group ID > 0 |
| } | | | |
| . . . | | | |

Secondly, a format of the newly defined AAI_DSA-RSP message is as shown in Table 10 below.

TABLE 10

| Field | Size(bit) | Value/Description | Condition |
|---|---|---|---|
| . . . | | | |
| For (i=0; | | Num of Multicast Group ID | Present when |
| i<Num of | | is the number of Multicast | Num of Multicast |
| Multicast | | Group IDs to add | Group ID > 0 |
| Group ID; | | [1 . . . 16] | |
| i++) { | | | |
| Multicast | 12 | ID of a group to which | |
| Group ID | | the flow is added | |
| MFID | 4 | FID which is associated with | Present when |
| | | Multicast Group IDs | Num of Multicast |
| | | | Group ID > 0 |
| } | | | |
| . . . | | | |

Thirdly, a format of the newly defined AAI_DSC-REQ message is as shown in Table 11 below.

TABLE 11

| Attributes/Array | | | |
|---|---|---|---|
| of attributes | Size(bit) | Value/Note | Condition |
| . . . | | | |
| For (i=0; i<Num | | Num of Multicast Group | Present when ABS |
| of Multicast | | ID is the number of | initiates AAI-DSC- |
| Group ID; | | Multicast Group IDs to | REQ |
| i++) { | | add [1 . . . 16] | Present only if |
| | | | Num of Multicast |
| | | | Group ID > 0 |
| Multicast Group | 12 | Multicast Group ID to be | |
| ID to be added | | added | |
| MFID | 4 | FID which is associated | Present if N>0 |
| | | with newly added | |
| | | Multicast Group IDs | |
| } | | | |
| For (i=0;i<Num | | Num of Multicast Group | Present when ABS |
| of Multicast | | ID is the number of | initiates AAI-DSC- |
| Group ID; i++) { | | Multicast Group IDs to | REQ |
| | | delete [1 . . . 16] | Present only if |
| | | | Num of Multicast |
| | | | Group ID > 0 |
| Multicast Group | 12 | Multicast Group ID to be | |
| ID to be deleted | | deleted | |
| } | | | |
| . . . | | | |

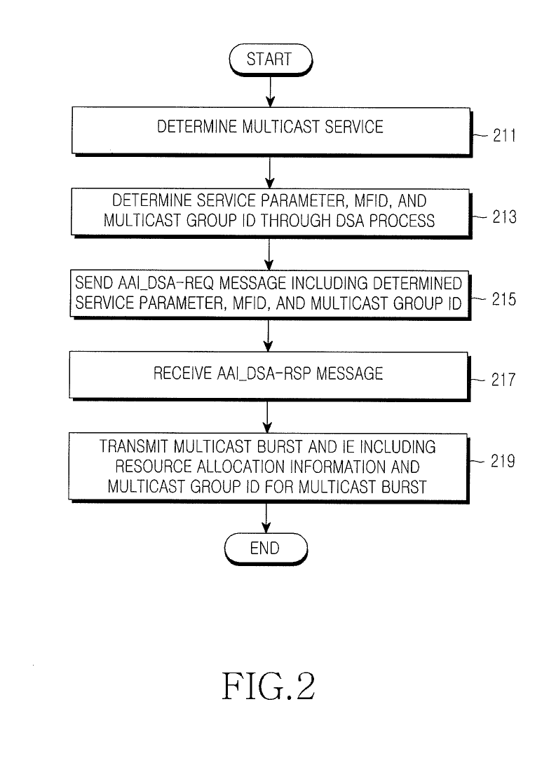

An operation of a BS in an IEEE 802.16m communication system according to an exemplary embodiment of the present invention will now be described with reference to FIG. 2.

FIG. 2 illustrates an operation of a BS in an IEEE 802.16m communication system according to an exemplary embodiment of the present invention.

Referring to FIG. 2, in step 211, the BS determines a multicast service to provide. In step 213, the BS determines service parameters, an MFID and a multicast group ID(s) through a DSA process. In step 215, the BS sends an AAI_DSA-REQ message including the determined service parameters, MFID and multicast group ID, to an MS. In step 217, the BS receives an AAI_DSA-RSP message from the MS in response to the AAI_DSA-REQ message. In step 219, the BS transmits an Information Element (IE) including resource allocation information and a multicast group ID for a multicast burst, to the MS together with the multicast burst. The IE may be, for example, a Broadcast Assignment Advanced (A)-MAP IE, and an AGMH in the multicast burst may include an MFID instead of an FID.

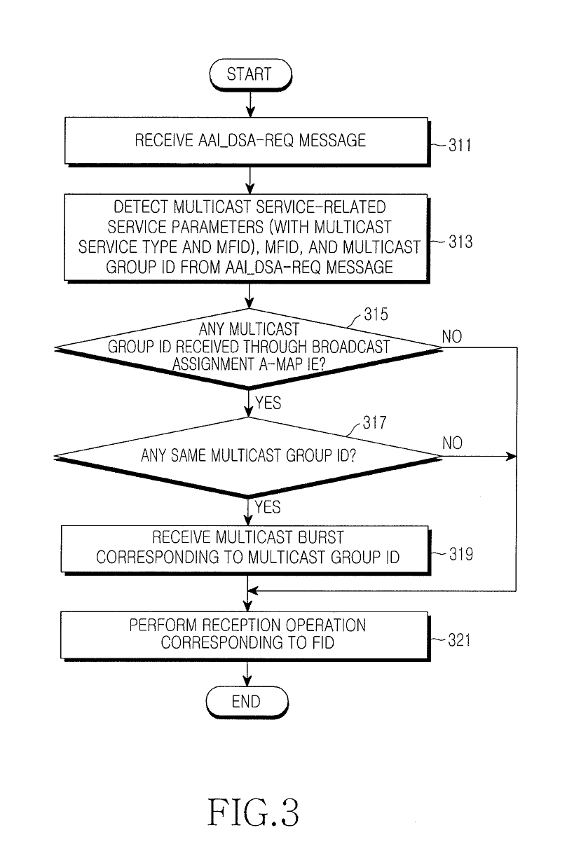

An operation of an MS in an IEEE 802.16m communication system according to an exemplary embodiment of the present invention will now be described with reference to FIG. 3.

FIG. 3 illustrates an operation of an MS in an IEEE 802.16m communication system according to an exemplary embodiment of the present invention.

Referring to FIG. 3, in step 311, the MS receives an AAI_DSA-REQ message from a BS. In step 313, the MS detects multicast service-related service parameters (including a multicast service type and an MFID), an MFID, and a multicast group ID(s) from the received AAI_DSA-REQ message. In step 315, the MS determines if a multicast group ID received using a Broadcast Assignment A-MAP IE is present, in every sub-frame. If the multicast group ID received using the Broadcast Assignment A-MAP IE is determined to be present at step 315, the MS determines in step 317 whether the same multicast group ID as the multicast group ID received using the Broadcast Assignment A-MAP IE exists among the multicast group IDs detected from the AAI_DSA-REQ message. In contrast, if the multicast group ID received using the Broadcast Assignment A-MAP IE is not determined to be present at step 315, the process proceeds to step 321 and the MS performs a reception operation corresponding to the detected FID.

If the same multicast group ID as the multicast group ID received using the Broadcast Assignment A-MAP IE is determined at step 317 to exist among the multicast group IDs detected from the AAI_DSA-REQ message, the MS receives a multicast burst corresponding to the multicast group ID in step 319. In the case of the multicast burst, because an MFID instead of an FID is included in an AGMH, the MS may detect an FID mapped to an MFID while performing a DSA process or a DSC process based on the MFID included in the AGMH. In step 321, the MS performs a reception operation corresponding to the detected FID. In contrast, if the same multicast group ID as the multicast group ID received using the Broadcast Assignment A-MAP IE is determined at step 317 to not exist among the multicast group IDs detected from the AAI_DSA-REQ message, the process proceeds to step 321 and the MS performs a reception operation corresponding to the detected FID.

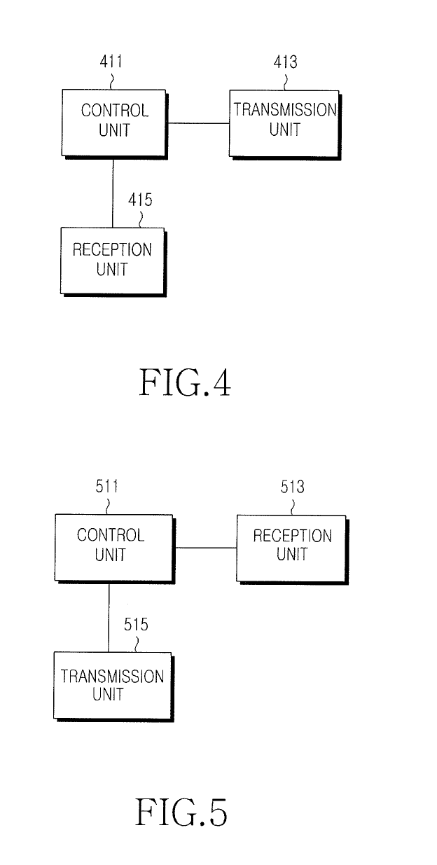

An internal structure of a BS in an IEEE 802.16m communication system according to an exemplary embodiment of the present invention will now be described with reference to FIG. 4.

FIG. 4 illustrates an internal structure of a BS in an IEEE 802.16m communication system according to an exemplary embodiment of the present invention.

Referring to FIG. 4, the BS includes a control unit 411, a transmission unit 413, and a reception unit 415.

The control unit 411 controls the overall operation of the BS, i.e., various operations for providing multicast services, and especially generates various messages like those described in connection with Tables 3 to 5. The transmission unit 413 sends various messages generated by the control unit 411 to an MS(s) under control of the control unit 411. The reception unit 415 receives various signals from the MS under control of the control unit 411.

Although the control unit 411, the transmission unit 413, and the reception unit 415 are realized in individual units in the example of FIG. 4, it will be understood by those of ordinary skill in the art that they may be realized in a single unit.

An internal structure of an MS in an IEEE 802.16m communication system according to an exemplary embodiment of the present invention will now be described with reference to FIG. 5.

FIG. 5 illustrates an internal structure of an MS in an IEEE 802.16m communication system according to an exemplary embodiment of the present invention.

Referring to FIG. 5, the MS includes a control unit 511, a reception unit 513, and a transmission unit 515.

The control unit 511 controls the overall operation of the MS. The reception unit 513 processes or handles various signals and messages received from a BS, and then outputs the results to the control unit 511. The various signals and messages received from the BS have been described above, so a detailed description thereof will be omitted for simplicity. The transmission unit 515 transmits various signals and messages to the BS under control of the control unit 511.

Although the control unit 511, the reception unit 513 and the transmission unit 515 are realized in individual units in the example of FIG. 5, it will be understood by those of ordinary skill in the art that they may be realized in a single unit.

As is apparent from the foregoing description, exemplary embodiments of the present invention make it possible to provide a multicast service using a multicast group ID(s), a Flow ID (FID), and a Multicast FID (MFID).

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing a multicast service by a Base Station (BS) in a communication system, the method comprising:
providing a multicast service to a Mobile Station (MS) using a multicast group IDentifier (ID) used to uniquely identify a multicast service in a network, and a Flow ID (FID) used along with the multicast group ID to uniquely identify a multicast flow in the network.

2. The method of claim 1, wherein the providing of the multicast service comprises:
sending to the MS an Advanced Air Interface Dynamic Service Allocation Request (AAI_DSA-REQ) message including information about a number of multicast group IDs, the multicast group ID, and the FID; and
receiving from the MS an Advanced Air Interface Dynamic Service Allocation Response (AAI_DSA-RSP) message including information about the number of multicast group IDs, the multicast group ID, and the FID.

3. The method of claim 2, wherein the providing of the multicast service further comprises sending an Advanced Generic Medium Access Control (MAC) Header (AGMH) including the FID, to the MS.

4. The method of claim 3, wherein the AGMH is transmitted through a multicast burst, and further includes length information of the multicast burst.

5. The method of claim 1, wherein the providing of the multicast service comprises sending to the MS an Advanced Air Interface Dynamic Service Change Request (AAI_DSC-REQ) message including information about a number of added multicast group IDs, a multicast group ID to be added, an FID of the multicast group ID to be added, information about a number of deleted multicast group IDs, and a multicast group ID to be deleted.

6. A method for receiving a multicast service by a Mobile Station (MS) in a communication system, the method comprising:
receiving a multicast service from a Base Station (BS) using a multicast group IDentifier (ID) used to uniquely identify a multicast service in a network, and a Flow ID (FID) used along with the multicast group ID to uniquely identify a multicast flow in the network.

7. The method of claim 6, wherein the receiving of the multicast service comprises:
receiving from the BS an Advanced Air Interface Dynamic Service Allocation Request (AAI_DSA-REQ) message including information about a number of multicast group IDs, the multicast group ID, and the FID; and
sending to the BS an Advanced Air Interface Dynamic Service Allocation Response (AAI_DSA-RSP) message including information about the number of multicast group IDs, the multicast group ID, and the FID.

8. The method of claim 7, wherein the receiving of the multicast service further comprises receiving an Advanced Generic Medium Access Control (MAC) Header (AGMH) including the FID, from the BS.

9. The method of claim 8, wherein the AGMH is received through a multicast burst, and further includes length information of the multicast burst.

10. The method of claim 6, wherein the receiving of the multicast service comprises receiving from the BS an Advanced Air Interface Dynamic Service Change Request (AAI_DSC-REQ) message including information about a number of added multicast group IDs, a multicast group ID to be added, an FID of the multicast group ID to be added, information about a number of deleted multicast group IDs, and a multicast group ID to be deleted.

11. A Base Station (BS) in a communication system, the BS comprising:
a control unit for controlling to provide a multicast service to a Mobile Station (MS) using a multicast group IDentifier (ID) used to uniquely identify a multicast service in a network, and a Flow ID (FID) used along with the multicast group ID to uniquely identify a multicast flow in the network.

12. The BS of claim 11, further comprising:
a transmission unit for sending an Advanced Air Interface Dynamic Service Allocation Request (AAI_DSA-REQ) message including information about a number of multicast group IDs, the multicast group ID, and the FID, to the MS under control of the control unit; and
a reception unit for receiving an Advanced Air Interface Dynamic Service Allocation Response (AAI_DSA-RSP) message including information about the number of multicast group IDs, the multicast group ID, and the FID, from the MS under control of the control unit.

13. The BS of claim 12, wherein the transmission unit sends an Advanced Generic Medium Access Control (MAC) Header (AGMH) including the FID, to the MS under control of the control unit.

14. The BS of claim 13, wherein the AGMH is transmitted through a multicast burst, and further includes length information of the multicast burst.

15. The BS of claim 11, further comprising a transmission unit for sending an Advanced Air Interface Dynamic Service Change Request (AAI_DSC-REQ) message including information about a number of added multicast group IDs, a multicast group ID to be added, an FID of the multicast group ID to be added, information about a number of deleted multicast group IDs, and a multicast group ID to be deleted, to the MS under control of the control unit.

16. A Mobile Station (MS) in a communication system, the MS comprising:
a control unit for controlling to receive a multicast service from a Base Station (BS) using a multicast group IDentifier (ID) used to uniquely identify a multicast service in a network, and a Flow ID (FID) used along with the multicast group ID to uniquely identify a multicast flow in the network.

17. The MS of claim 16, further comprising:
a reception unit for receiving an Advanced Air Interface Dynamic Service Allocation Request (AAI_DSA-REQ) message including information about a number of multicast group IDs, the multicast group ID, and the FID, from the BS under control of the control unit; and
a transmission unit for sending an Advanced Air Interface Dynamic Service Allocation Response (AAI_DSA-RSP) message including information about the number of multicast group IDs, the multicast group ID, and the FID, to the BS under control of the control unit.

18. The MS of claim 17, wherein the reception unit receives an Advanced Generic Medium Access Control (MAC) Header (AGMH) including the FID, from the BS under control of the control unit.

19. The MS of claim 18, wherein the AGMH is received through a multicast burst, and further includes length information of the multicast burst.

20. The MS of claim 16, further comprising a reception unit for receiving an Advanced Air Interface Dynamic Service Change Request (AAI_DSC-REQ) message including information about a number of added multicast group IDs, a multicast group ID to be added, an FID of the multicast group ID to be added, information about a number of deleted multicast group IDs, and a multicast group ID to be deleted, from the BS under control of the control unit.
